(19) United States
(12) Patent Application Publication
(10) Pub. No.: US 2008/0250424 A1
(43) Pub. Date: Oct. 9, 2008

(54) Seamless Window Implementation for Windows Presentation Foundation based Applications

(75) Inventors: Ivan Brugiolo, Redmond, WA (US); Leonardo Blanco, Redmond, WA (US); Nadim Abdo, Bellevue, WA (US); Dorin Oreste Ungureanu, Duvall, WA (US)

Correspondence Address: LEE & HAYES PLLC, 421 W RIVERSIDE AVENUE SUITE 500, SPOKANE, WA, 99201, US

(73) Assignee: MS1 - Microsoft Corporation, Redmond, WA (US)

(21) Appl. No.: 11/696,577

(22) Filed: Apr. 4, 2007

(51) Int. Cl. G06F 9/44; G06F 15/16

(52) U.S. Cl. 719/315; 709/203

(57) ABSTRACT

Described are systems and methods for implementing seamless window support for applications, such as applications based on Windows® Presentation Foundation (WPF). Seamless support for WPF applications can be implemented by remoting information associated with structural representation of the applications from a remote server to a remote client. The structural representation may be replicated at the client in accordance with the structural information. The replicated structural representation is utilized to render visual content associated with the application by local rendering mechanisms at the client.

### BACKGROUND

Mechanisms and implementations for remoting of applications are some features provided in operating systems such as Microsoft® Windows® based operating systems. Remoting features allow remote access of one or more applications, rather than the entire desktop, when the applications themselves are hosted on a remote site, such as a server.

Applications hosted on a remote server, also referred to as remote applications, are usually accessible and visible through a proxy window, visible on the client end. A user thus interacts with the remote application through the proxy window.

Visual features associated with remote applications are rendered onto the client end through the proxy window, in a seamless manner. Such seamlessness enables the application to appear as if it were being accessed locally. Remoting of applications involves taking the rendered visual content associated with the remote application and replicating it at the client end. Furthermore, any changes due to the functioning of the remote applications are further replicated and displayed in the proxy window at the client end.

### SUMMARY

This summary is provided to introduce concepts relating to the implementation of seamless window support for applications based on Windows® Presentation Foundation (WPF). These concepts are further described below in the detailed description. This summary is not intended to identify essential features of the claimed subject matter, nor is it intended for use in determining the scope of the claimed subject matter.

A method is described of generating structural representation associated with an application, abstracting structural information from the structural representation, and transmitting the structural information along with render target information to create a render target at a remote device accessing the application.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates an exemplary system implementing seamless window support for applications based on Windows® Presentation Foundation (WPF).

FIG. 2 illustrates rendering of visual content onto a render target for GDI and WPF applications.

FIG. 3 illustrates an exemplary visual tree.

FIG. 4 illustrates an exemplary server-based device.

FIG. 5 illustrates an exemplary client-based device.

FIG. 6 illustrates interactions between various components for seamless window support for applications based on Windows® Presentation Foundation (WPF).

FIGS. 7 and 8 illustrates exemplary method(s) for providing seamless window support for applications based on Windows® Presentation Foundation (WPF).

### DETAILED DESCRIPTION

Systems and methods for implementing seamless window support for applications based on Windows® Presentation Foundation (WPF) are described. Seamless support for WPF applications can be implemented by remoting information associated with structural representation of the applications from a remote site (e.g., a server) to a remote end (e.g., a client). The structural representation is then replicated at the client end in accordance with the structural information. The replicated structural representation is utilized to render visual content associated with the application by local rendering mechanisms at the client end.

To implement this, a remoting module initiates a remote session with a server on which one or more of the applications are hosted. The WPF based applications are characterized by a structural representation used to generate a visual representation, and structural information. Structural representation includes a description of one or more primitive drawing operations used to produce the final visual content such as pens, brushes, and bitmaps to be drawn according to specified instructions in specified reciprocal positions. In one implementation, the structural representation can be depicted as a visual tree. Structural information specifies one or more structural aspects, such as size of application window, z-order, etc., of the application in a windowing system. In one implementation, structural information can be depicted as the information required to display a window in a windowing system and to rasterize the visual representation in a convenient part of a window in a windowing system.

The structural information is abstracted from the visual tree and is transferred to the client end. For example, the structural information transferred from server to client end is used to reconstruct the location of a visual tree associated with the application being remoted. The structural representation (i.e., the visual tree) is eventually utilized by the local client rendering module for rendering the visual contents of the remoted application.

The rendering is performed in a specific portion of the display area referred to as a render target. The rendering is performed for example by associating the structural representation with the render target. In one implementation, the render target is created at the client end in accordance with the structural information.

While aspects of described systems and methods for implementing seamless window support for applications based on Windows® Presentation Foundation (WPF) can be implemented in any number of different computing systems, environments, and/or configurations, the embodiments are described in the context of the following exemplary system architecture(s).

### An Exemplary System

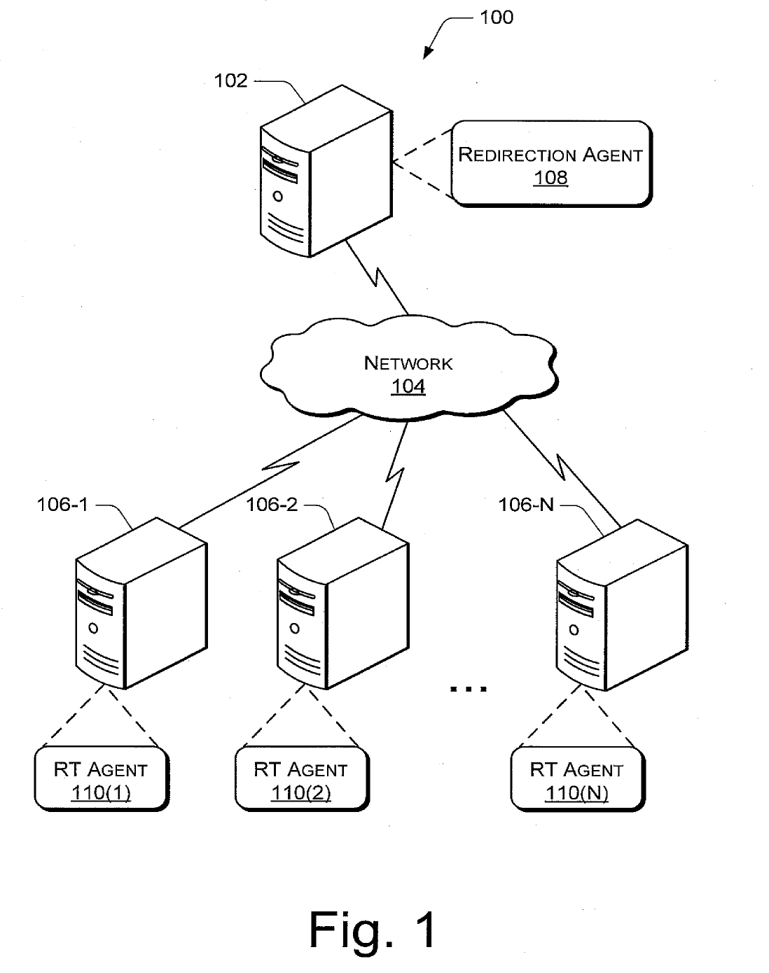

FIG. 1 shows an exemplary system 100 for implementing seamless window support for applications based on Windows® Presentation Foundation (WPF). To this end, the system 100 includes a server computing device 102 communicating through a network 104 with one or more client computing devices 106(1)-(N). For example, in one implementation, system 100 can be a company network, including thousands of office PCs, various servers, and other computing-based devices spread throughout several countries. Alternately, in another possible implementation, system 100 can include a home network with a limited number of PCs belonging to a single family.

System 100 may include or be similar to, a Terminal Service™ system by the Microsoft® Corporation, wherein the multiple client computing devices 106 access applications installed or hosted on server computing device 102. Therefore, client computing devices 106 wishing to access applications hosted on server computing device 102 interact with the application through a proxy window. The proxy window displayed at the client end replicates the output and the visual contents associated with the applications that would be rendered on server computing device 102. This enables a user on any one or more of client computing devices 106 to access the application directly without remoting the desktop associated with server computing device 102. The user on any one or more of client computing devices 106 is provided with the experience as if accessing the application locally. It is to be understood that access may be provided for a definite number of applications, or for all applications, hosted on server computing device 102.

Applications and services hosted on server computing device 102 are accessible by client computing devices 106 by using remote client access system such as Terminal Services™ system. Client computing devices 106 can be coupled to each other or to server computing device 102 in various combinations through a wired and/or wireless network, including a LAN, WAN, or any other networking technology known in the art. Server computing device 102 and client computing devices 106 maybe implemented with an operating system supporting applications based on WPF. For example, client computing devices 106 may be provided with operating systems that include, but are not limited to various operating systems by the Microsoft® Corporation.

Server computing device 102 includes a redirection agent 108. Redirection agent 108 is capable of instrumenting the remoting of applications hosted on server computing device 102, to client computing devices 106. To implement this, redirection agent 108 collects and transfers structural information associated with desired applications and renders visual content associated with them. The rendered visual content is limited to the region belonging to the window but not being covered by the render target. The visual contents associated with the structural representation are rendered in accordance with the region and location specified in the structural information, on one or more of client computing devices 106. Redirection agent 108 defines a render target on one or more of client computing devices 106. The render target defined by redirection agent 108 is created by a render target or RT agent 110 (illustrated by RT agents 110(1), . . . , 110(N)). For example, render target is defined on the basis of structural information transferred from server computing device 102 to client computing devices 106 and finally shaped by RT agent 110.

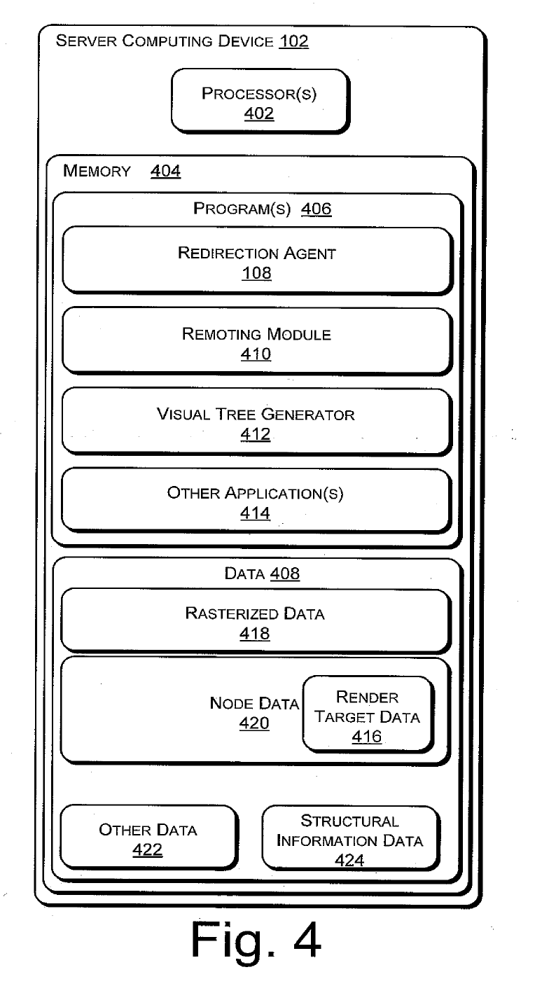

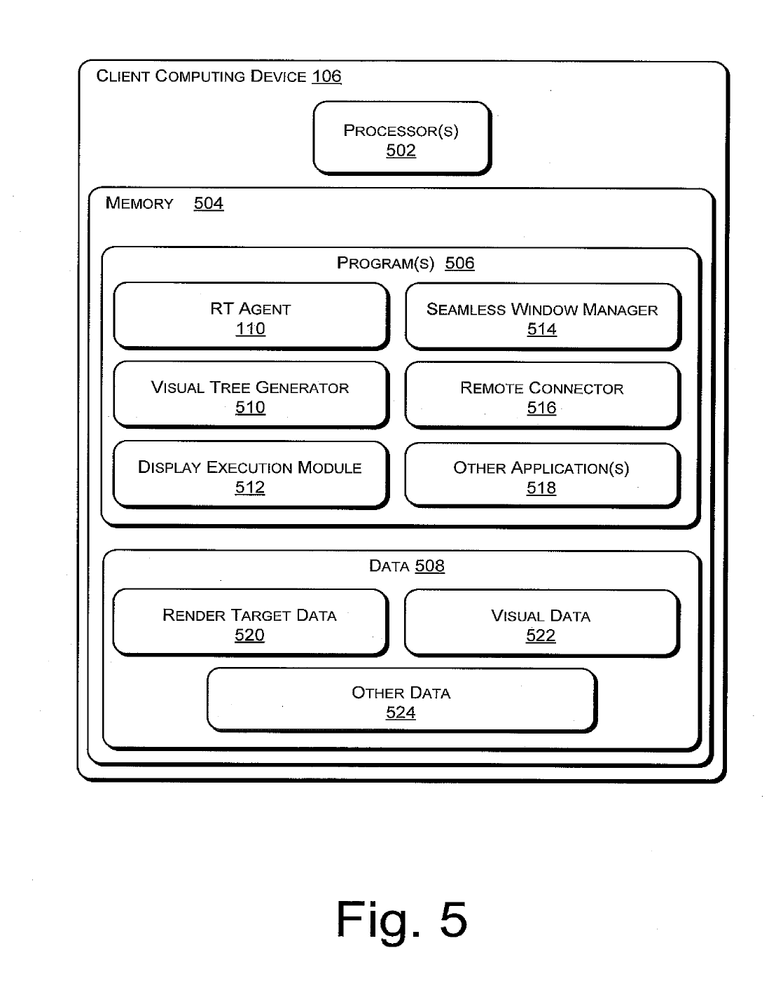

In one implementation, RT agent 110 also associates the visual representation replicated at the client end with the render target created at the client end. Upon association, the visual contents are rendered onto the display area of client computing devices 106 using local rendering mechanisms. In this manner, visual contents associated with remoted applications are not rendered at the server computing device 102, but at the client end, namely one or more of client computing devices 106. Such mechanisms reduce resource load on server computing device 102 as the rendering process is appropriated to the pertinent client computing devices 106. The manner of implementing seamless window support for applications based on Windows® Presentation Foundation (WPF) is further explained in detail in conjunction with FIGS. 4 and 5.

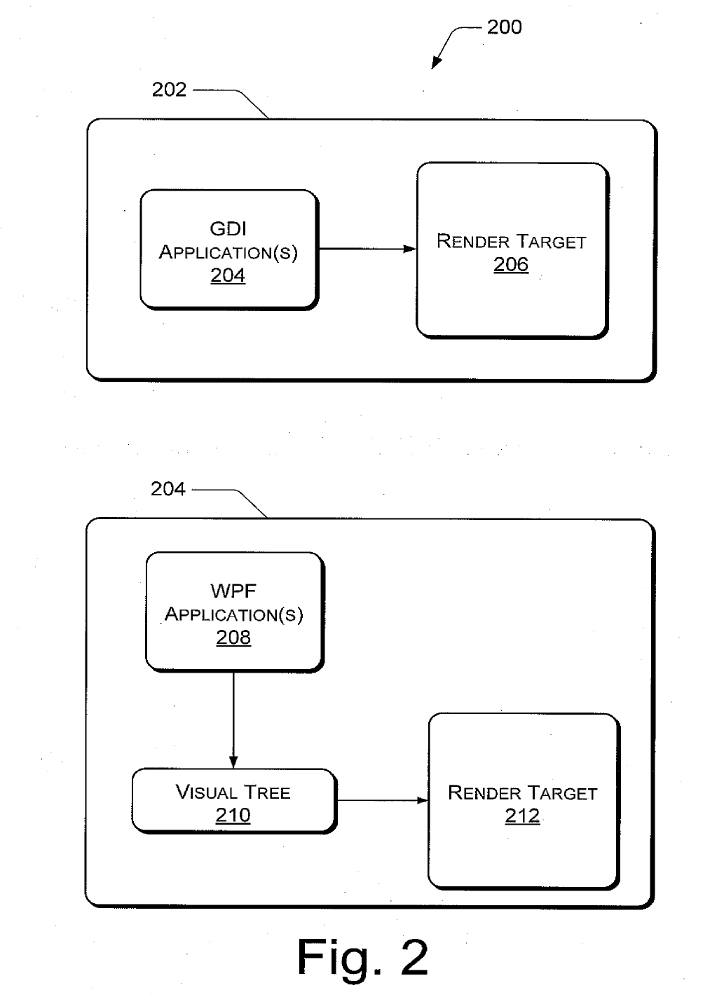

FIG. 2 illustrates the manner in which various types of computer based applications (e.g., GDI applications or WPF applications) render their associated visual content on a desktop of a computing-based device. Generally, a user can interact with an application through an interface (e.g., a window). Data generated as a result of the execution of such applications is visible in a window, within a display area, associated with the application.

Block 202 illustrates the rendering of the visual content associated with GDI application(s) 204 onto a render target 206. A render target may be defined as a region where all rasterized and rendered pixels are placed. A portion of a frame buffer is an example of a render target. GDI application(s) 204 generally render their visual content in an immediate drawing mode. In such a case, GDI application(s) 204 direct their output straight to render target 206 (e.g., a frame buffer). Hence, each time a drawing or a visual representation is created by GDI application(s) 204 it is directly rendered onto the frame buffer. In case some changes occur in GDI application(s) 204, their entire visual content is again re-rendered onto the frame buffer. It should be understood that GDI application(s) 204 rasterize and render the visual content to be displayed thereby making no logical distinction between describing the drawing operation and executing (via rasterization and rendering processes) the drawing operation.

Block 204 illustrates the rendering of visual content associated with WPF application(s) 208. Rendering visual content in WPF application(s) 208 may differ from rendering in GDI application(s) 204, because unlike GDI application(s) 204, the visual contents of a WPF application(s) 208 that are to be displayed, are not rendered directly to a frame buffer. In the case of WPF application(s) 208, the associated visual contents are stored separately in, for example, a storage buffer. The visual contents can be generated by a rasterizing module.

For example, in an operating system, the visual content is stored as a structural representation referred to as visual tree 210. Visual tree 210 has core visual content and related information, as represented by nodes. The nodes may specify attributes like spatial placement, size of the application window, etc. The nodes may have explicit drawing instructions and drawing resources associated with them.

A display execution module responsible for displaying WPF application(s) 208 content, selects portions of the visual tree for display onto render target 212 (e.g., a frame buffer). The display execution module can be a WPF rendering thread. For rendering the visual contents in conformance with visual tree 210, the WPF rendering thread traverses all nodes of visual tree 210 and rendering visual content in conformance with visual tree 210. For any changes made by the executing applications there are corresponding changes to nodes of visual tree 210. The WPF rendering thread can also note changes to visual tree 210 and re-renders portions that are specific to the changes affected by the executing applications.

It is to be noted that the manner in which a desktop is accessed remotely, differs from the remote accessing of applications. For example, in case an application is accessed remotely, a visual tree corresponding to the application is created first. The visual content is then rendered in conformance with the structural representation (i.e., the visual tree). As discussed previously, a visual tree may denote only a structural representation (such as: elements to be drawn, drawing primitives, drawing instructions), and not the visual representation of the desktop. Therefore, it can be gathered that a visual tree separates the visual from the structural characteristic of the visual contents of the desktop.

For rendering, a display execution module subsequently associates attributes (e.g., effects, transformations, etc.) with the visual elements and creates a point-in-time visual representation of the visual tree. In the case of certain operating systems, composition may be managed by an operating system component referred to as a Desktop Window Manager (DWM).

In the case of remoting of application hosted on a remote site, for example server computing device 102, the rendered visual contents are not directly displayed onto the display device at the server computing device 102. The rendered portions of the visual contents are remoted to one or more of client computing devices 106 in an immediate drawing mode. For example, the visual contents rendered at server computing device 102 is extracted from frame buffer of server computing device 102 and transferred to the frame buffer of one or more of client computing devices 106 from where it is eventually displayed.

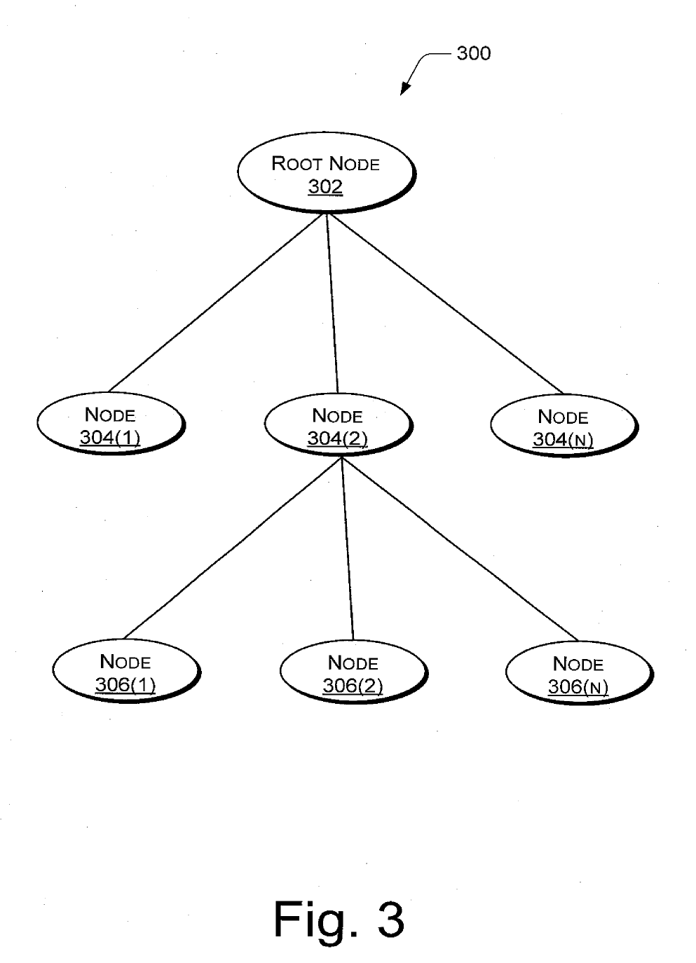

FIG. 3 illustrates an exemplary visual tree 300. Visual tree 300 includes a root node 302 (associated with a rendering target node) and one or more of children nodes 304, 306, for example nodes 304(1), . . . 304(N), and 306(1), . . . 306(N). Each of the children nodes 304, 306 derive an association from the node on which it depends. For example, nodes 304 depend on root node 302 defining additional attributes to root node 302. In a similar fashion, nodes 306 depend on one of the nodes 304, for example node 304(2).

Visual tree 300 represents a possible instance of structural representation associated with an application running on server computing device 102. For example, if a plurality of applications is being accessed, a control component in server computing device 102 manages the arrangement of application windows. This arrangement translates as one of the many attributes that define visual tree 300. Each of the application windows are associated with one or more attributes that define the manner in which the visual contents of the associated applications are displayed. Examples of such attributes include, but are not limited to, clipping portion, visibility, etc.

Root node 302 typifies an application running on a server, such as server computing device 102. As indicated previously, root node has one or more of children nodes 304, 306. Children nodes (i.e., nodes 304) indicate one or more properties that define the manner in which the visual content is eventually rendered and displayed on the display device of a computing device, say server computing device 102. For example, node 304 may correspond to information about a non-client area of an application, system defined buttons, application specific control buttons, etc. Each node may contain specific information regarding the drawing resource and drawing instructions to be executed in order to create a visual representation of the node in a render target.

Visual contents are then rendered in accordance with the structural representation such as a visual tree. Rendering is performed by a rendering module that traverses the nodes of the visual tree, for example visual tree 300. Depending on the nature of attributes defined in the children nodes for example, nodes 304, 306, the rendering module places a pixel onto the frame buffer. The entire traversing of the visual tree by the rendering module generates the visual representation of the contents that are associated with the application being rendered. Other visual content belonging to the application and not described by the structural representation, may be rendered in immediate drawing mode at the server, and replicated at the client. The structural information describes how the visual content rendered by walking the visual tree 300 and the immediate drawing mode content are to be combined. The rendered visual contents are finally displayed on a display device for example, a monitor. As indicated previously, it should be appreciated that the rendering in this manner differs from the direct rendering of the visual contents onto the frame buffer as illustrated for GDI application(s) 204.

FIG. 4 illustrates relevant exemplary components of server computing device 102. Server computing device 102 can include one or more processor(s) 402 and a memory 404. Processor(s) 402 may include microprocessors, microcomputers, microcontrollers, digital signal processors, central processing units, state machines, logic circuitries, and/or any devices that manipulate signals based on operational instructions. Among other capabilities, processor(s) 402 are configured to fetch and execute computer-readable instructions stored in memory 404.

Memory 404 can include any computer-readable medium known in the art including, for example, volatile memory (e.g., RAM) and/or non-volatile memory (e.g., flash, etc.). As illustrated in FIG. 4, memory 404 also can include program(s) 406 and data 408. Program(s) 406 include, for example, redirection agent 108, a remoting module 410, a visual tree generator 412 and other application(s) 414. Other application(s) 414 include programs that supplement applications on any computing based device such as word processor applications, spreadsheet applications, and such. In yet another implementation, the applications that are being remoted can be based on WPF, for example WPF application(s) 208. Data 408 include, for example, render target data 416, rasterized data 418, node data 420, other data 422, and structural information data 424. In a particular implementation, there is a visual tree generator 412 for each WPF application.

A remote session is initiated by a user (i.e., one or more of client computing devices 106). Remoting module 410 initiates the remote session on receiving a request from one or more of client computing devices 106 and affects the execution of the application that is requested from the user. The execution of application is followed by the generation of the structural information. The execution of the application is then followed by the generation of a visual tree, such as visual tree 300. In an implementation, visual tree 300 is generated by visual tree generator 412. The visual tree contains visual information defining the visual elements, their relationship, the drawing resource and the drawing instructions. In certain cases, the visual tree 300 associated with an application can be generated by the application itself, leveraging the visual tree generator 412. The execution of the application causes the redirection agent to produce structural information defining the manner in which the associated visual content would be displayed in a windowing system. In an embodiment, the structural information may associate the client-area of a window with the render target of a visual tree, and the non-client area of a window with immediate-mode GDI content rasterized at the server.

The structural information associated with a visual tree, such as visual tree 300, can be stored. For example, node data 420 stores structural representation (i.e., visual tree information). As indicated earlier, redirection agent 108 collects and transfers structural information from server computing device 102 to client computing devices 106. The visual tree generator 412 transfers node data 420 that corresponds to structural representation associated with applications that are running on server computing device 102, and the corresponding visual tree(s). The remote connection established by remoting module 410 provides a mechanism for the transmission of structural information and node data 420 between server computing device 102 and client computing devices 106.

The applications running on server computing device 102 have a visual tree (e.g., visual tree 300), associated with it. In one possible implementation, redirection agent 108 abstracts structural information from a visual tree associated with an application. Visual tree 300 generated for each application running on server computing device 102 is generated by a generating module, such as visual tree generator 412.

Visual tree 300 can also include information that relates to the render target and its attributes. A render target can be considered to be an area where the visual contents associated with an application are rendered. Information specifying attributes for the render target can be stored for example, in render target data 416.

To implement seamless window support for applications based on Windows® Presentation Foundation (WPF), redirection agent 108 abstracts structural information associated with an application on server computing device 102. The structural information is produced by the Redirection Agent with information coming from the window manager running at the server. The node data 420 is obtained from a visual tree 300 associated with the application. Redirection agent 108 also acquires render target information from render target data 416. The render target information can also be acquired from a visual tree, for example, redirection agent 108 can acquire render target information from visual tree 300.

Redirection agent 108 then instruments transmission of node data 420 from server computing device 102 to the client end, such as one or more of client computing devices 106. It should be noted that one or more client computing devices 106 initiate the remote session for accessing the applications hosted on server computing device 102. Redirection agent 108 communicates structural, to one or more of client computing devices 106 for rendering visual content onto them.

In an implementation, node data 420 and render target data 416 can be transmitted as Media Infrastructure Layer (MIL) Commands. Infrastructure supporting MIL commands allow for a generic transport to be opened against a rendering device. The transport is abstracted in a handle to a MIL based connection, which creates a connection bound to a remote device, such as one or more of client computing devices 106.

In an implementation, structural information can be transmitted as Remote Desktop Protocol (RDP) extension. RDP extension commands are received by the Seamless Window Manager 514 and the RT Agent 110

FIG. 5 illustrates relevant exemplary components of one or more of client computing devices 106. Client computing devices 106 can include one or more processor(s) 502 and a memory 504. Processor(s) 502 may include microprocessors, microcomputers, microcontrollers, digital signal processors, central processing units, state machines, logic circuitries, and/or any devices that manipulate signals based on operational instructions. Among other capabilities, processor(s) 502 are configured to fetch and execute computer-readable instructions stored in memory 504.

Memory 504 can include any computer-readable medium known in the art including, for example, volatile memory (e.g., RAM) and/or non-volatile memory (e.g., flash, etc.). Memory 504 also can include program(s) 506 and data 508. Program(s) 506 include, for example, RT agent 110, visual tree generator 510, display execution module 512, seamless window manager 514, remote connector 516 and other application(s) 518. Other application(s) 518 include programs that supplement applications on any computing based device such as word processor applications, spreadsheet applications, and such. In yet another implementation, the applications that are remoted from server computing device 102 can be based on WPF, for example WPF application(s) 208. Data 508 include, for example, render target data 520, visual data 522 and other data 522.

The remote session initiated by one or more of client computing devices 106 may be performed through remote connector 516. The structural and render target information associated with the remoted applications is received by one or more of client computing devices 106, for example by RT agent 110 or by the seamless window manager 514. The structural information is used by client computing devices 106 to render the visual contents of the applications to which the structural information corresponds.

To render the visual contents associated with the remoted applications, a render target is defined. A render target can be considered as an area in which the visual contents are rendered. RT agent 110 utilizes the render target information received from server computing device 102 to define a render target on client computing devices 106. To define a render target, a window is created and render target information is associated with it. For example, seamless window manager 514 creates a window on client computing devices 106 and RT agent 110 associates the render target information with it. The association between render target information and the created window may be implemented by the application being remoted. Furthermore, render target information can be stored in render target data 520.

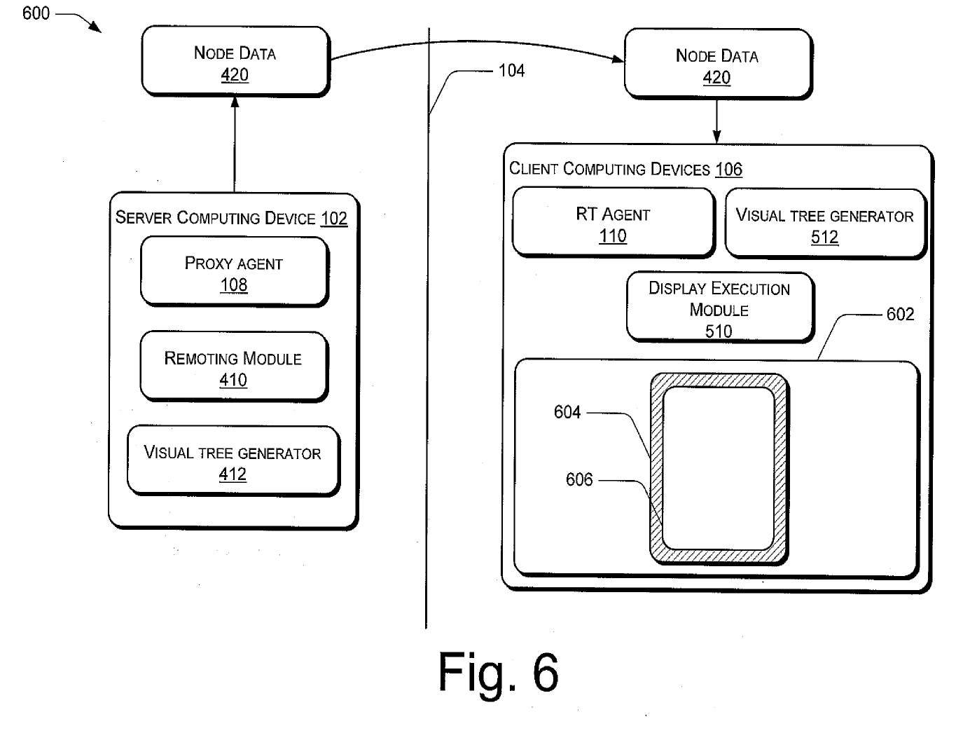

The structural information is utilized to correctly replicate the structural representation at the client end. The replicated structural representation is the same as the structural representation generated at the server end during execution of the associated application. It should be noted that the structural representation of the visual contents is instrumental in rendering the visual contents. Structural representation at the client computing device can be used by the display execution module 512 to provide the different regions as will be discussed below in FIG. 6.

A visual tree is generated at one or more of client computing devices 106, in accordance with node data 420 transmitted from server computing device 102 to client computing devices 106. For example, visual tree 300 can be generated by visual tree generator 510 in accordance with node data 420.

The replicated structural representation or visual tree is associated with the render target defined at one or more of client computing devices 106, for example by RT agent 110. This allows the display of the visual contents represented by the structural representation in the render target defined at the client end (i.e., at one or more of client computing devices 106). In order to display the visual contents in the defined render target, display execution module 512 traverses through the nodes (e.g., nodes 304, 306) of visual tree associated with the defined render target. Depending on the information included in the nodes, display execution module 512 renders the visual contents accordingly onto the render target. In one implementation, root node 302 of visual tree 300 is associated with the defined render target for displaying visual contents of the associated applications.

Render target may include a frame buffer in each of client computing devices 106. The rendered visual contents are then taken from the frame buffer and displayed onto the display device of client computing devices 106, for example, a display monitor. Seamless window manager 514 performs the translation between the remote window application or the proxy window and the local window. This results in seamlessness between the local window and the remoted application window.

In an implementation, structural information is received as extension of the Remote Desktop Protocol by the RT agent and the Seamless Window Manager. The Seamless Window Manager can create a proxy window in order to host the render target, and the RT agent can associate the inner area 608 (related to area 606, associated to the proxy window) with the render target for the visual tree 300.

In an implementation, node data 420 and render target data 416 are received by Visual Tree generator 512 as Media Infrastructure Layer (MIL) Commands. Infrastructure supporting MIL commands allow for a generic transport to be opened against a rendering device, for example display execution module 510. The transport is abstracted in a handle to a MIL based connection, which creates a connection bound to a remote device, for example, one or more of client computing devices 106.

### Exemplary Method(s)

An exemplary method for implementing seamless window support for applications based on Windows® Presentation Foundation (WPF) is described with reference to FIGS. 1 to 5 and FIG. 6 in particular. FIG. 6 shows a series of exemplary interactions between the server computing device 102 and client computing devices 106 for implementing seamless window support for WPF based applications. The exemplary method may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices. FIG. 6 includes a frame buffer 602 that define two regions, an outer region 604 and inner region 606. Structural representation at a client computing device can be used by the display execution module 512 to provide the different regions 606 and 608, where the inner region 608 is mapped to the render target for the visual tree. Structural information can also be used to confine the rendering area of a visual tree in a render target. For example, visual tree 300 can be associated with the region 608.

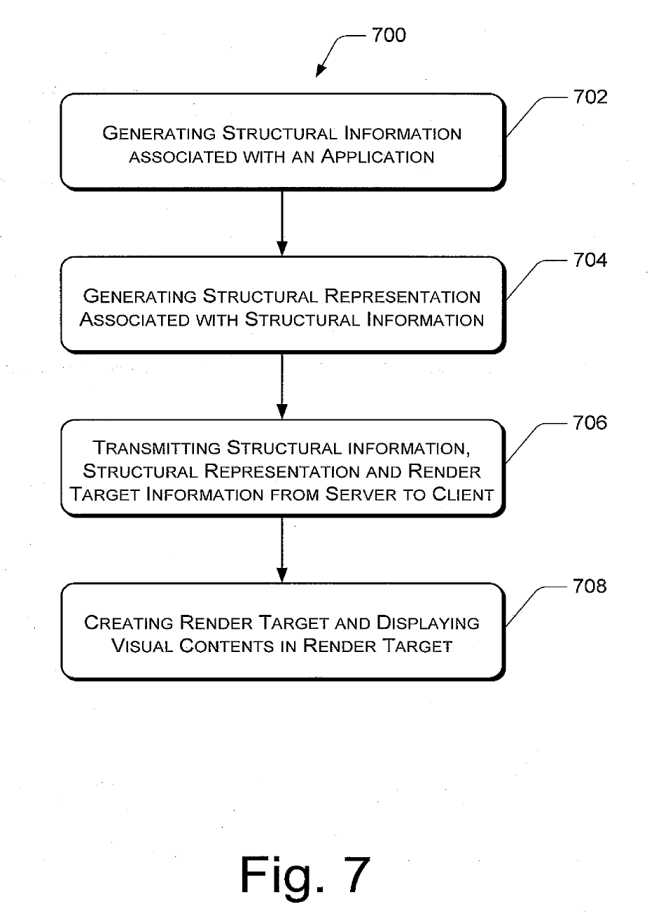

FIG. 7 illustrates an exemplary method 700 for implementing seamless window support for applications based on Windows® Presentation Foundation (WPF). The order in which the method is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the method can be implemented in any suitable hardware, software, firmware, or combination thereof.

At block 702, structural information associated with an application is generated. For example, redirection agent 108 abstracts structural information from the location where a visual tree associated with an application needs to be rendered. In an implementation, this separation is used to separate the visual elements required for the interaction with the window manager and the visual representation created by the application.

At block 704, structural representation associated with the structural information is abstracted from it. For example, visual tree generator 412 generates a visual tree associated with one or more applications that are requested for access from client computing devices 106. As discussed, a visual tree is a structural representation of the visual contents of the applications being remoted. In an implementation, the applications can be based on Windows® Presentation Foundation (WPF), for example WPF application(s) 208 In one implementation, visual tree 300 can also include information that relates to the render target and its attributes. A render target can be considered to be an area where the visual contents associated with an application is rendered. Information specifying attributes for the render target can be stored for example, in render target data 416.

As illustrated in FIG. 6, server computing device 102 interacts with one of client computing devices 106 through a server-client interface. Examples of such interface includes, but are not limited to server-client network in which both server computing device 102 and client computing devices 106 may be a part of. The network can be wireless or wired, or a combination of both, and can include any number of server computing device 102 or client computing devices 106.

Server computing device 102 includes among other components or modules, redirection agent 108, remoting module 410, and visual tree generator 412. Returning to the interactions between server computing device 102 and client computing devices 106, it can be gathered that the execution of application as a result of a request made from a remote client, client computing devices 106, generates a visual tree. The visual tree, for example, visual tree 300, is generated by visual tree generator 412.

In an implementation, redirection agent 108 gathers structural information from the window manager regarding the location of the generated visual tree, for example visual tree 300. The structural information gathered by redirection agent 108 is stored in structural redirection data 423. Redirection agent 108 may also acquire render target information from render target data 416 or directly from a visual tree 300. As discussed, render target information includes information that would define attributes pertinent to the render target for displaying visual content.

At block 706, structural information, structural representation and render target information are transmitted from the server end to the client end. For example, redirection agent 108 transmits the abstracted structural information, structural representation and render target information or node data 420 and structural information data 423 from server computing device 102 to client computing devices 106. The transmission of the abstracted information or node data 420 is performed over the server-client interface, such as network 104.

Node data 420 and render target data 416 can also be transmitted as Media Infrastructure Layer (MIL) Commands. Infrastructure supporting MIL commands allow for a generic transport to be opened against a rendering device. The transport is abstracted in a handle to a MIL based connection, which creates a connection bound to a remote device, such as one or more of client computing devices 106.

At block 708, a render target is created at the client end and visual contents associated with the applications being remoted are rendered within the render target. For example, RT agent 110 in client computing devices 106 creates a render target, in accordance with the render target information received from server computing device 102. The render target is defined in the frame buffer of client computing devices 106, such as frame buffer 604 in FIG. 6. The render target (e.g., render target 606) defined in frame buffer 604 is created in conformance with the received render target information.

Visual tree generator 510 in client computing devices 106 further may generate a visual tree in accordance with node data 420. It should be appreciated that the visual tree generated at one or more of client computing devices 106, is a replica of the visual tree generated at client computing devices 106, when the remote application was being executed.

The display execution module of the local device, like one of client computing devices 106, renders the visual contents onto the render target created at the client end. For example, display execution module 512 renders the visual data 522 in window 608. Visual data 522 rendered onto frame buffer 604, is displayed on a display device, such as a display monitor, of one of client computing devices 106.

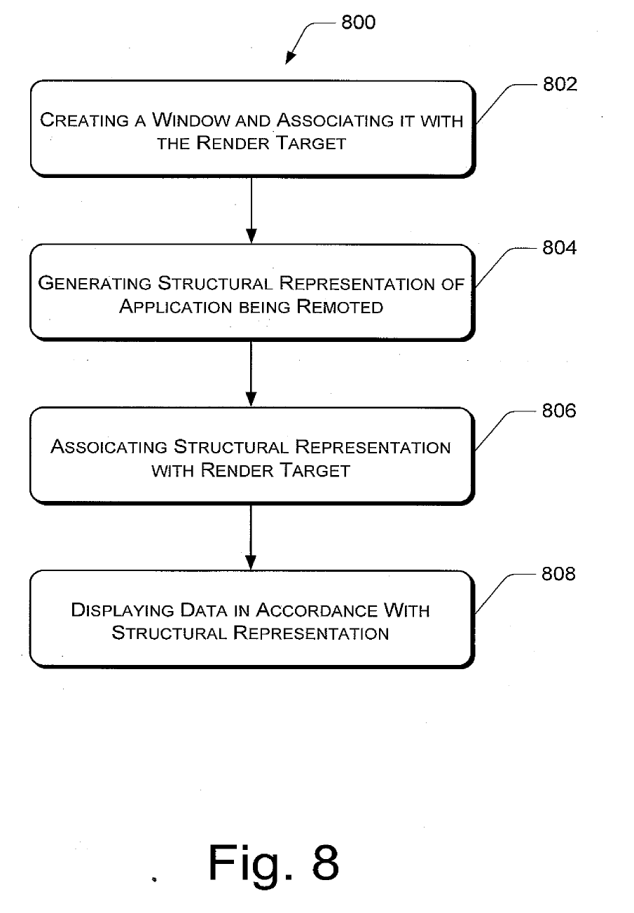

The manner in which visual contents are displayed in render target are further described in conjunction with FIG. 8. FIG. 8 illustrates an exemplary method 800 for displaying visual contents in a render target. The order in which the method is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the method can be implemented in any suitable hardware, software, firmware, or combination thereof.

At block 802, a window is created at the client side. For example, Seamless window manager 514 creates a window on client computing devices 106 and the RT Agent 106 associates the render target information with it resulting in render target 608 contained in frame buffer 606 according to the structural information data 424 transmitted by the redirection agent 108 at the server end. In an implementation, the association between render target information and the created window may be implemented by the application being remoted. Render target information can be stored in render target data 520. Render target 606 is created onto a frame buffer of client computing devices 106.

At block 804, structural representation associated with an application being remoted is generated. For example, visual tree generator 510 on client computing devices 106 generates a structural representation or visual tree, such as visual tree 300. Visual tree 300 is generated on the basis of the structural representation data 424 received from server computing device 102 in the form of node data 420. Visual tree generator 510 therefore replicates the visual tree as created on server computing device 102, on the basis of node data 420. It should be noted that the structural information relates to the applications that are running on server computing device 102 and remoted from it.

At block 806, the structural representation (or the generated visual tree 300) is associated with the render target. For example, RT agent 110 associates the structural representation (i.e., visual tree 300) with the render target 608.

At block 808, visual contents are displayed onto the render target in accordance with the structural representation. For example, in order to display the visual contents in the defined render target 606, display execution module 512 traverses through the nodes (e.g., nodes 304, 306), of visual tree associated with render target 606. Depending on the information included in the nodes 304, 306, display execution module 512 renders the visual contents accordingly onto the render target. Root node 302 of visual tree 300 may be associated with the defined render target for displaying visual contents of the associated applications.

Render target 606 may include a frame buffer in each of client computing devices 106. The rendered visual contents or visual data 522 are taken from the frame buffer and displayed onto the display device of client computing devices 106, for example, a display monitor. The visual contents are displayed in a manner which allows users of one or more of client computing devices 106 to access applications hosted on server computing device 102 as if they were installed locally.

### CONCLUSION

Although embodiments for implementing seamless window support for applications based on Windows® Presentation Foundation (WPF) have been described in language specific to structural features and/or methods, it is to be understood that the subject of the appended claims is not necessarily limited to the specific features or methods described. Rather, the specific features and methods are disclosed as exemplary implementations for providing seamless window support for applications based on Windows® Presentation Foundation (WPF).

What is claimed is:

1. A server computing device comprising:
a memory;
one or more processors operatively coupled to the memory;
a redirection agent in the memory, wherein the redirection agent collects and transfers structural information from the server computing device to a client computing device.

2. The server computing device of claim 1, wherein the redirection agent abstracts node data from a visual tree associated with an application, in a form of the structural information.

3. The server computing device of claim 2, wherein the visual tree includes information as to a render target and attributes of the render target.

4. The server computing device of claim 2, wherein the redirection agent instruments transmission of node data and structural information data from the server computing device to the client computing device.

5. The server computing device of claim 4, wherein the node data and render target data are transmitted as Media Infrastructure Layer (MIL) commands.

6. The server computing device of claim 1 further comprising a remoting module that initiates a remote session on the server computing device based on a request by a client computing device to access an application hosted on the server computing device, wherein the structural information is based on the application.

7. The server computing device of claim 1 further comprising a visual tree generator that creates a visual tree representative of the structural representation.

8. A client computing device comprising:
a memory;
one or more processors operatively coupled to the memory; and
a render target agent in the memory, wherein the render target agent utilizes render target information and structural information received from a server computing device to define a render target on the client computing device.

9. The client computing device of claim 8, wherein the render target information and node data are received by the visual tree generator as Media Infrastructure Layer (MIL) commands.

10. The client computing device of claim 8, further comprising a seamless window manager agent that creates a window, and the render target agent associates the render target with the window.

11. The client computing device of claim 8 further comprising a visual tree generator that creates a visual tree based on nodes associated with the structural representation.

12. The client computing device of claim 8 further comprising a display execution module that displays visual contents by traversing through nodes of a visual tree associated with the render target.

13. The client computing device of claim 8 further comprising a seamless window module that performs translation between a remote proxy window at the server computing device and a local window at the client computing device.

13. A method of comprising:
generating structural information associated with an application;
generating structural representation associated with structural information; and
transmitting the structural information and structural representation along with render target information to create a render target.

14. The method of claim 13, wherein the method is performed at a server computing device, and the render target is created at a remote client computing device.

15. The method of claim 13, wherein the generating is performed by a visual tree generator, and the structural representation is a visual tree associated with one or more applications.

16. The method of claim 13, wherein the abstracting is performed by a redirection agent that abstracts structural information data from node data of visual tree associated with an application.

17. The method of claim 13, wherein the render target is created with visual contents associated with remote applications.

18. The method of claim 13 further comprising creating a window at a client computing device, and associating the render target information with the window.

19. The method of claim 13, regenerating at a client computing device, the structural representation.

20. The method of claim 13, displaying at a client computing device visual contents onto the render target associated with the structural representation.
